(19) United States
(12) Patent Application Publication
(10) Pub. No.: US 2015/0139793 A1
(43) Pub. Date: May 21, 2015

(54) COOLING FAN MOUNTING DEVICE AND IMAGE FORMING APPARATUS INCLUDING SAME

(71) Applicant: Gakushi TANAKA, Kanagawa (JP)

(72) Inventor: Gakushi TANAKA, Kanagawa (JP)

(73) Assignee: RICOH COMPANY, LTD., Tokyo (JP)

(21) Appl. No.: 14/513,330

(22) Filed: Oct. 14, 2014

(30) Foreign Application Priority Data
Nov. 15, 2013 (JP) 2013-236781

(51) Int. Cl. F04D 29/64; F04D 19/00; F04D 29/52; G03G 21/20

(52) U.S. Cl. CPC F04D 29/646; G03G 21/206; F04D 19/002; F04D 29/522
USPC 415/213.1

(57) ABSTRACT

A mounting device for a cooling fan includes a fan housing, an impeller; and a mounting surface with a projection to secure the cooling fan, in which a space between the fan housing and the impeller at an intake side is different from a space between the fan housing and the impeller at an exhaust side, and the projection has such a height as to cause the impeller to contact the projection only when the cooling fan is mounted backwards.

### CROSS-REFERENCE TO RELATED APPLICATION

The present application claims priority pursuant to 35 U.S.C. §119(a) from Japanese patent application number 2013-236781, filed on Nov. 15, 2013, the entire disclosure of which is incorporated by reference herein.

### BACKGROUND

1. Technical Field

Exemplary embodiments of the present invention relate to a mounting device for a cooling fan used for an image forming apparatus such as an electrostatic copier or printer.

2. Background Art

Image forming apparatuses in general include a fan to cool an interior of the apparatus. Such a fan is first mounted to a duct or a plate and the duct or the plate including the fan is then mounted to the apparatus body. An axial-flow fan, in general, is formed symmetrically, including a blower side and an intake side. As a result, to prevent the fan from being attached backwards during assembly, the attachment direction is engraved or indicated by an attached decal. Even in this case, however, human error may occur, and such an error cannot be detected in advance.

Considering the above problem, the present invention provides a fan with a simple structure to prevent improper installation.

### SUMMARY

In one embodiment of the disclosure, there is provided a novel mounting device for a cooling fan that includes a fan housing, an impeller; and a mounting surface with a projection to secure the cooling fan, in which a space between the fan housing and the impeller at an intake side is different from a space between the fan housing and the impeller at an exhaust side, and the projection has such a height as to cause the impeller to contact the projection only when the cooling fan is mounted backwards. In one embodiment, there is also provided an image forming apparatus that includes a mounting device for a cooling fan, in which the mounting device includes a fan housing; an impeller; and a mounting surface with a projection to secure the cooling fan.

These and other objects, features, and advantages of the present invention will become apparent upon consideration of the following description of the preferred embodiments of the present invention when taken in conjunction with the accompanying drawings.

### BRIEF DESCRIPTION OF THE DRAWINGS

FIG. 1 illustrates a general outline of an image forming apparatus in which is mounted a cooling fan according to an embodiment of the present invention;

FIG. 2 is a perspective view illustrating a mounting device for a cooling fan according to a first embodiment of the present invention;

FIG. 3 is a perspective view illustrating a duct of the mounting device;

FIGS. 4A and 4B are perspective and side views of the cooling fan, respectively;

FIG. 5 is a cross-sectional view of a projection forming a part of the mounting device; and

FIG. 6 is an enlarged cross-sectional view of the projection in the mounting device for the cooling fan according to the first embodiment of the present invention.

### DETAILED DESCRIPTION

Herein, referring to drawings, an embodiment of the present invention will be described.

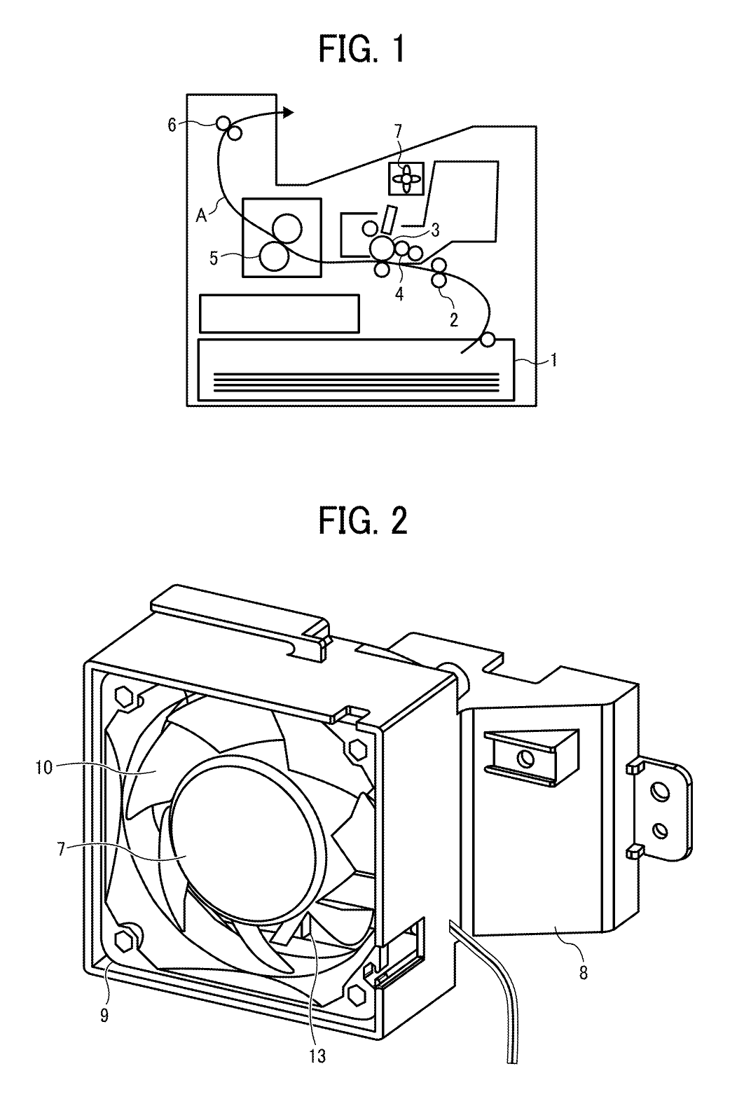

FIG. 1 illustrates an exemplary structure of an image forming apparatus in which a mounting device for a cooling fan is used. As illustrated in FIG. 1, a transfer material such as a sheet of paper or the like is fed out from a tray 1 and is conveyed in a direction indicated by arrow A. The transfer material passes through a registration roller pair 2 and reaches a transfer section, where it contacts an image carrier 3. Meanwhile, toner is supplied from a developing device 4 to an electrostatic latent image formed on the image carrier 3, to thus form a toner image thereon. Image formation is based on image signals obtained by laser beams modulated according to image data. The toner image reaches the transfer section and is transferred to the transfer material. The transfer material then passes through a fixing device 5, which fixes the toner image onto the transfer material. The transfer material then passes through a discharge roller pair 6 to be discharged outside the apparatus. The fixing device 5 is capable of withstanding very high temperatures, but the image carrier 3 and the developing device 4 are not. To cool the image carrier 3 and the developing device 4, a fan 7 is disposed.

### First Embodiment

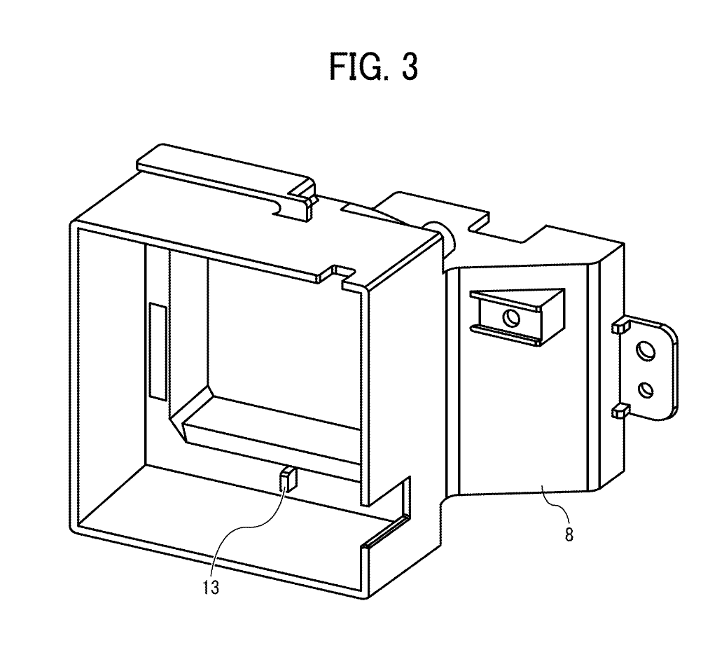

A first embodiment of the present invention will be described with reference to FIGS. 2 to 5.

As described above, the image forming apparatus includes the fan 7 to cool the interior of the apparatus. The fan 7 for ventilation is often first mounted to a duct 8 or a plate and is then mounted to the apparatus body. In the mounting device for the fan 7, a space between a fan housing 9 and an impeller 10 is different at an intake side and an exhaust side, in that the intake side space 11 is shorter than the exhaust side space 12. In addition, the fan 7 as illustrated includes a sensor for lock detection.

The duct 8 includes a mounting surface to secure the fan 7. The mounting surface includes a projection 13. The height of the projection 13 is such that it causes the impeller 10 to contact the projection 13 only when the fan 7 is mounted backwards.

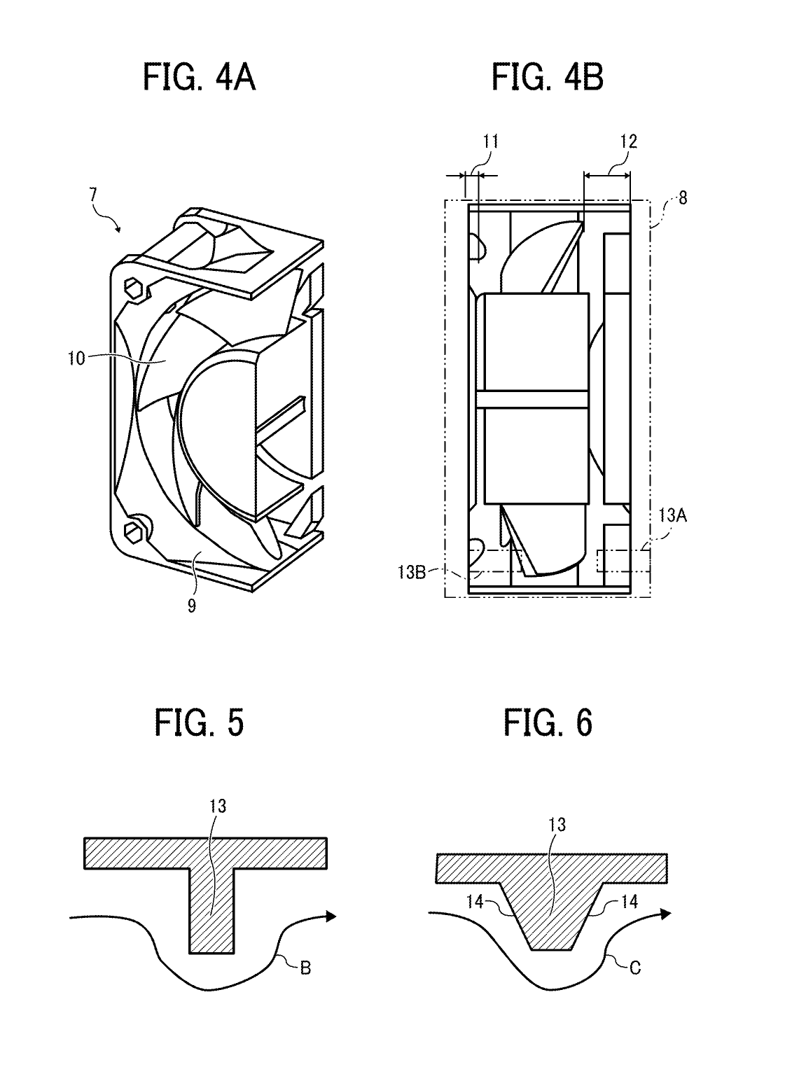

Specifically, when the fan 7 is mounted backwards and the projection 13 is positioned at 13B as illustrated in FIG. 4B, because the intake side space 11 is smaller than the exhaust side space 12, the projection 13 abuts the impeller 10. By contrast, when the fan 7 is correctly mounted, the projection 13 is positioned at 13A. Accordingly, with a simple structure, the fan 7 can be prevented from being improperly mounted to the apparatus.

Alternatively, that the projection 13 and the impeller 10 make contact with each other may be detected by the sensor. Any one of various sensors may be employed as appropriate.

### Second Embodiment

Referring to FIG. 6, a second embodiment of the present invention will be described.

It is to be noted that the basic structure of the mounting device for the fan according to the second embodiment is the same as that of the first embodiment.

In the second embodiment, sides 14 of the projection 13 are sloped, such that the projection 13 is broader at the base than at the tip. As a result, in the normal operation of the fan 7, resistance of the projection 13 to an airflow C can be reduced to prevent noise and the airflow amount can be prevented from being reduced compared to an airflow B in FIG. 5. The both sloped sides 14 are opposite each other and one side is opposed to an airflow generated by the impeller 10 in a rotation direction of the impeller 10. Sloped portions may be disposed at other sides, if any. The present invention is not limited to the above-described embodiments, and additional modifications and variations are possible in light of the above teachings. It is therefore to be understood that, within the scope of the appended claims, the invention may be practiced other than as specifically described herein.

What is claimed is:

1. A mounting device for a cooling fan, comprising:
a fan housing;
an impeller; and
a mounting surface with a projection to secure the cooling fan,
wherein a space between the fan housing and the impeller at an intake side is different from a space between the fan housing and the impeller at an exhaust side, and
the projection has such a height as to cause the impeller to contact the projection only when the cooling fan is mounted backwards.

2. The mounting device for a cooling fan as claimed in claim 1,
wherein the projection has sloped sides.

3. The mounting device for a cooling fan as claimed in claim 1, wherein the side surfaces of the projection include a first surface opposite the impeller in a rotation direction of the impeller and a second surface opposite and paired with the first surface.

4. An image forming apparatus comprising a mounting device for a cooling fan, the mounting device comprising:
a fan housing;
an impeller; and
a mounting surface with a projection to secure the cooling fan,
wherein a space between the fan housing and the impeller at an intake side is different from a space between the fan housing and the impeller at an exhaust side, and
the projection has a height such as to cause the impeller to contact the projection only when the cooling fan is mounted backwards.
